(19) United States
(12) Patent Application Publication
(10) Pub. No.: US 2016/0112421 A1
(43) Pub. Date: Apr. 21, 2016

(54) METHOD AND APPARATUS FOR SELECTIVE ACTIVATION OF UNIVERSAL SERIAL BUS (USB) PORTS

(71) Applicant: Xerox Corporation, Norwalk, CT (US)

(72) Inventors: MICHAEL H. WANG, Macedon, NY (US); Francis Kapo Tse, Rochester, NY (US); Steve Schlonski, Webster, NY (US)

(21) Appl. No.: 14/518,660

(22) Filed: Oct. 20, 2014

(51) Int. Cl. H04L 29/06; G06F 13/42; G06F 13/38

(52) U.S. Cl. CPC H04L 63/0892; G06F 13/382; G06F 13/4282; H04L 63/0853; H04L 63/0492

(57) ABSTRACT

A method, non-transitory computer readable medium, and apparatus for selectively activating a universal serial bus (USB) port are disclosed. For example, the method receives a predefined list of services that are acceptable to work with the USB port, configures the USB port based on the predefined list of services, receives an indication that a service is requested via the USB port and provides the service via the USB port when the USB port is configured to provide the service based on the predefined list of services.

The present disclosure relates generally to managing universal serial bus (USB) ports and, more particularly, to a method and apparatus for selective activation of USB ports.

### BACKGROUND

Some customers prohibit the use of certain devices on endpoint devices. For example, the federal government may prohibit the use of any USB based storage devices such as USB thumb drives within certain federal government facilities.

Currently, to implement such requests on endpoint devices, the USB ports on the endpoint device must be all turned off or on. In other words, current solutions only provide an “all or nothing” approach. However, if the USB port is turned off, then the USB port may be unavailable for other functions or protocols that could be needed for other services via the USB port.

### SUMMARY

According to aspects illustrated herein, there are provided a method, a non-transitory computer readable medium, and an apparatus for selectively activating a universal serial bus (USB) port. One disclosed feature of the embodiments is a method that receives a predefined list of services that are acceptable to work with the USB port, configures the USB port based on the predefined list of services, receives an indication that a service is requested via the USB port and provides the service via the USB port when the USB port is configured to provide the service based on the predefined list of services.

Another disclosed feature of the embodiments is a non-transitory computer-readable medium having stored thereon a plurality of instructions, the plurality of instructions including instructions which, when executed by a processor, cause the processor to perform operations that receives a predefined list of services that are acceptable to work with the USB port, configures the USB port based on the predefined list of services, receives an indication that a service is requested via the USB port and provides the service via the USB port when the USB port is configured to provide the service based on the predefined list of services.

Another disclosed feature of the embodiments is an apparatus comprising a processor and a computer readable medium storing a plurality of instructions which, when executed by the processor, cause the processor to perform operations that receives a predefined list of services that are acceptable to work with the USB port, configures the USB port based on the predefined list of services, receives an indication that a service is requested via the USB port and provides the service via the USB port when the USB port is configured to provide the service based on the predefined list of services.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of an endpoint device of the present disclosure;

FIG. 2 illustrates an example flowchart of one embodiment of a method for selectively activating a universal serial bus (USB) port; and

FIG. 3 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for selectively activating a universal serial bus (USB) port. As discussed above, currently USB ports on endpoint devices must be all turned off or on. In other words, current solutions only provide an “all or nothing” approach. In other words, there is no current way to configure one USB port on an endpoint device to provide one or more services and allow a different USB port on the same endpoint device to provide a different set of one or more services.

Embodiments of the present disclosure provide a way to configure each USB port on an endpoint device to provide one or more different services. In other words, each one of a plurality of different USB ports on the same endpoint device may be configured to be selectively activated based on the service or services the USB port is configured to provide.

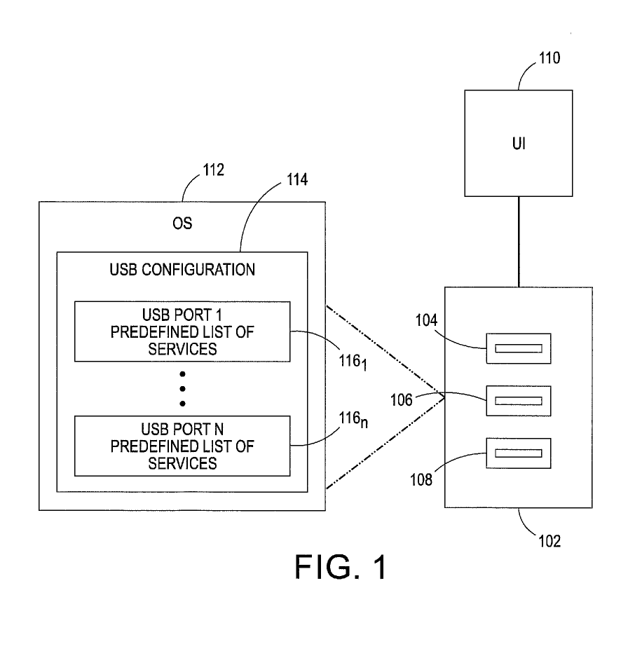

FIG. 1 illustrates an example endpoint device 102 having one or more USB ports 104, 106 and 108. In one embodiment, the endpoint device 102 may be a personal computer, a peripheral device, a printer, a multi-function device, a television set or any other endpoint device that uses USB ports. In one embodiment, the USB ports 104, 106 and 108 may be any type of USB ports including USB 2.0, USB 3.0, and the like. Although FIG. 1 illustrates three USB ports on the endpoint device 102, it should be noted that the endpoint device may have any number of USB ports (e.g., more or less than three).

In one embodiment, the endpoint device 102 may include a user interface (UI) 110. For example, the UI 110 may include graphical display and an input means. The input means may be a key pad or key board or may be a touch screen on the graphical display. The UI 110 may be used by a user or an administrator to specify which of the USB ports 104, 106 and 108 should be configured to provide one or more predefined services.

In one embodiment, each one of the USB ports 104, 106 and 108 may be configured for selective activation based upon one or more specific services that are requested. As a result, the embodiments of the present disclosure allow for more granular control of each one of the USB ports 104, 106 and 108 rather than an all or nothing approach that requires the USB ports 104, 106 and 108 to be completely on or off.

In one embodiment, the operating system (OS) 112 of the endpoint device 102 may contain a USB configuration file 114. The USB configuration file 114 may contain configuration information 116₁ to 116ₙ (herein also referred to as configuration information 116) for each one of the USB ports 104, 106 and 108. In one embodiment, the configuration information 116 for each corresponding USB port 104, 106 and 108 may be based upon a predefined list of services.

For example, the system administrator of the endpoint device 102 may provide a list of predefined services for each one of the USB ports 104, 106 and 108. The endpoint device 102 may then use the list of predefined services received for USB port 104 and store the list of predefined services in the configuration information 116₁ used to configure the USB port 104. The process may be repeated for configuration information 116₂ for the USB port 106, the configuration information 116₃ for the USB port 108, and so forth.

In one embodiment, the list of predefined services may include any type of service that may be provided via the USB ports 104, 106 and 108. For example, the types of services may include external storage via USB thumb drive, USB thumb drive printing, near field communications (NFC) tap to print, a USB firmware update, a USB authentication, authorization and accounting (AAA) card authentication, and the like. The examples listed above are not exhaustive and other services may be within the scope of the present disclosure.

In one embodiment, the predefined list of services may include a communication protocol used by each one of the services. For example, USB thumb drive printing may use a communication protocol that may be different from a communication protocol used by storage services via a USB thumb drive. The communication protocol information may also help the endpoint device 102 recognize what type of service is being requested via one of the USB ports 104, 106 and 108 in determining if the service is available via a selected USB port, as discussed below.

As discussed above, the system administrator may configure each one of the USB ports 104, 106 and 108 based upon a predefined list of services that is acceptable to work with a respective USB port 104, 106 or 108. For example, the predefined list of services for the USB port 104 may include thumb drive printing and NFC tap to print services, the predefined list of services for the USB port 106 may include USB firmware updates and the predefined list of services for the USB port 108 may include AAA card authentication. In one embodiment, some services may be globally turned on or off for each one of the USB ports 104, 106 and 108. For example, the system administrator may block all USB thumb drive storage services for each one of the USB ports 104, 106 and 108.

In yet another embodiment, each one of the USB ports 104, 106 and 108 may be individually turned on or off. For example, USB port 106 may be turned off and the USB ports 104 and 108 may be turned on and configured based upon a respective predefined list of services.

Based on the predefined list of services, each one of the USB ports 104, 106 and 108 may be configured to selectively activate when one of the services in the predefined list of services is requested. Using the above example configurations, a user may insert a USB thumb drive print request into the USB port 104. The USB port 104 may receive an indication via a communications protocol for USB thumb drive printing initiated by the USB thumb drive inserted into the USB port 104. The endpoint device 102 may check the configuration information 116₁ for the USB port 104 and confirm that USB thumb drive printing is allowed via the USB port 104 and provide the requested services.

However, if the user inserts the USB thumb drive print request into the USB port 106, the endpoint device 102 may determine that USB thumb drive printing is not allowed on the USB port 106. In one embodiment, the endpoint device 102 may simply provide a message that the service is not available via the UI 110.

In another embodiment, the endpoint device 102 may check to see if the requested service is available on another USB port (e.g., USB port 104 or 108). Using the above example configuration, the endpoint device 102 may see that the USB thumb drive printing services are available on the USB port 104. As a result, the endpoint device 102 may provide a message to the user indicating that the USB thumb drive printing is not available on the USB port 106 that is selected, but the USB thumb drive printing is available on the USB port 104. The user may then remove the USB thumb drive print request from the USB port 106 and re-insert the USB thumb drive print request into the USB port 104.

In another example, a user may attempt to insert a USB thumb drive for external storage. However, the system administrator may have blocked all USB thumb drive storage devices for each one of the USB ports 102, 104 and 106. As a result, the user's request for storage onto the USB thumb drive may be denied.

In one embodiment, the predefined list of services may be adjusted on a per use basis via the UI 110 by any individual user and not just the system administrator. In other words, the endpoint device 102 may be configured for pay-per-use and users may adjust the configuration of a USB port based on whether a service requires a payment. For example, the USB port may be free for uploading and downloading data via USB thumb drive storage device so that the user may view an image via the UI 110. However, if the user then decides to print an image from the USB thumb drive storage device, the user may be prompted to pay to enable USB thumb drive printing services. Once payment is confirmed (e.g., via a credit card or account number), the endpoint device 102 may enable or add USB thumb drive printing services to the selected USB port 104, 106 or 108. Once the services are completed, the endpoint device 102 may then delete or disable the USB thumb drive printing services.

As noted above, in one embodiment, the endpoint device 102 may be a printer or a multi-function device (MFD). Typically, printers and MFDs do not provide the configurability of USB ports. In addition, modifying the operating system or software on printers and MFDs to provide granular control of the USB ports is often more difficult or complicated then attempting to provide such granular control on other endpoint devices, such as, personal computers, televisions, and the like.

As a result, the embodiments of the present disclosure allow a vendor to provide granular control of USB ports on endpoint devices for selective activation of each one of the USB ports. As a result, when a customer wants to block all USB thumb drive storage devices, but allow other services such as USB thumb drive printing, the embodiments of the present disclosure allow the USB ports of the endpoint device to be configured accordingly. The embodiments of the present disclosure can also provide significant cost savings as the vendor may not be required to deploy additional endpoint devices each having differently configured USB ports. Rather, a single endpoint device may be deployed where each one of the USB ports is configured based upon a predefined list of services as needed by the customer.

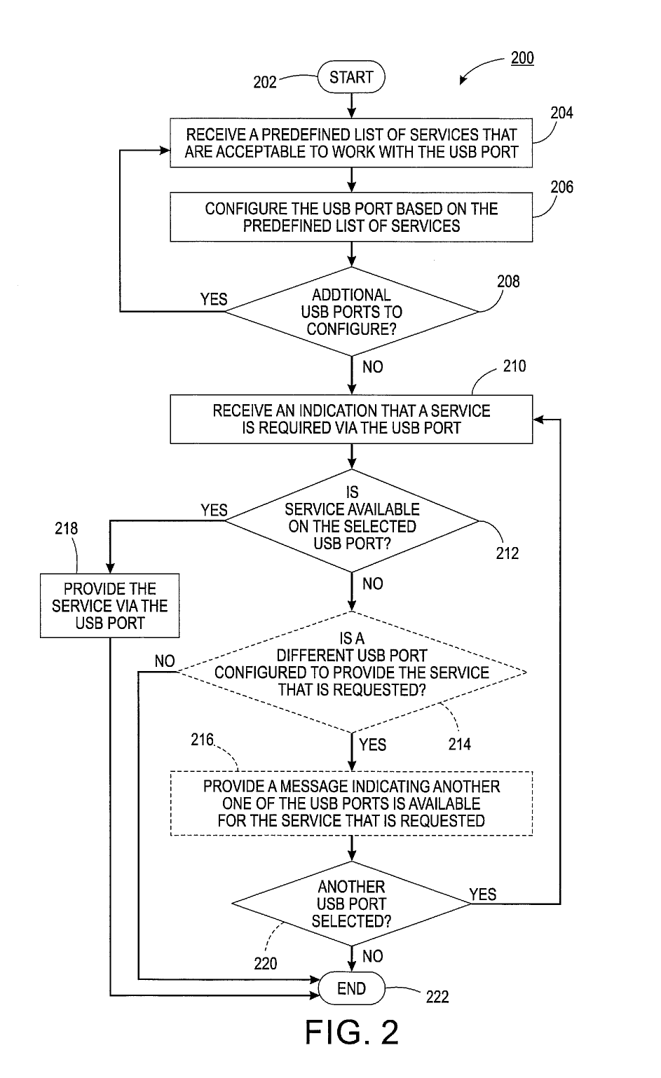

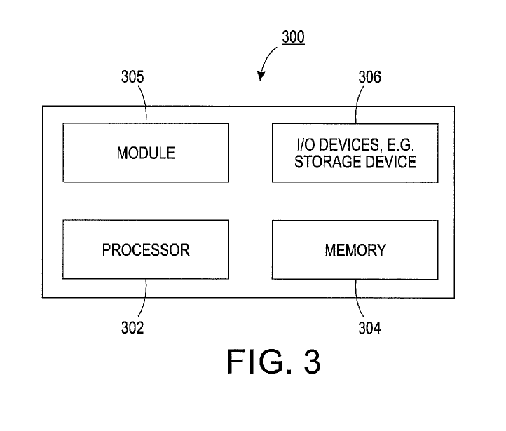

FIG. 2 illustrates a flowchart of a method 200 for selectively activating a universal serial bus (USB) port. In one embodiment, one or more steps or operations of the method 200 may be performed by the endpoint device 102 or a general-purpose computer as illustrated in FIG. 3 and discussed below.

At step 202 the method 200 begins. At step 204, the method 200 receives a predefined list of services that are acceptable to work with the USB port. For example, a system administrator may enter a predefined list of services via the UI of the endpoint device. In one embodiment, the predefined list of services may include, for example, storage via a USB thumb drive, thumb drive printing, NFC tap to print, USB firmware updates, AAA card authentication, or any other services that can be obtained via a USB port. In one embodiment, the predefined list of services may also include a communication protocol used by each one of the different services such that the endpoint device can identify what type of service an external USB device is requesting based on the communication protocol that is initiated by the external USB device.

At step 206, the method 200 configures the USB port based on the predefined list of services that is received. For example, a USB port configuration file in an operating system of the endpoint device may be modified to store the predefined list of services for a respective USB port.

At step 208, the method 200 determines if there are additional USB ports to configure. If there are additional USB ports to configure, the method 200 returns to step 204 and receives the predefined list of services for the next USB port. For example, the system administrator may enter a predefined list of services via the UI of the endpoint device to configure each one of a plurality of different USB ports. In one embodiment, each one of the different USB ports may be configured with a different set of services in a respective predefined list of services. For example, a first USB port and a third USB port may be configured to only allow USB printing and AAA authentication and a second USB port may be configured to only allow firmware updates via a USB storage device, and so forth. In one embodiment, all USB ports may be configured to reject a service globally. For example, all USB ports may be configured to deny services for storage onto a USB thumb drive device. However, if there are no additional USB ports to configure or all of the USB ports have been properly configured, the method 200 proceeds to step 210.

At step 210, the method 200 receives an indication that a service is requested via the USB port. For example, when an external USB device is inserted into a USB port, the external USB device may send an indication that the external USB device is requesting USB print services. In one embodiment, the indication may be a message sent as part of the communication protocol for the specific service that is being requested by the external USB device that is inserted into the USB port.

At step 212, the method 200 determines if the service that is requested is available on the selected USB port. For example, the endpoint device may determine the communication protocol is being used to request USB printing services. The endpoint device may then check the USB configuration file for the selected USB port and determine if USB printing service is in the predefined list of services for the selected USB port. If the service is available on the selected USB port, then the method 200 may proceed to step 218.

At step 218, the method 200 provides the service via the USB port. The method 200 then proceeds to step 222 where the method 200 ends.

Referring back to step 212, if the service that is requested is not available on the selected USB port (e.g., the requested service is not found in the predefined list of services for the selected USB port), then the method 200 may proceed to optional steps 214-220 or proceed directly to step 222 where the method 200 ends.

If the method 200 proceeds to optional step 214, the method 200 determines if there is a different USB port configured to provide the service that is requested. For example, the endpoint device may search the USB port configuration files or the predefined list of services that each USB port is configured based on to see if there is a USB port that can provide the service that is requested. If another USB port is not found, the method 200 may proceed to step 222 where the method 200 ends. In one embodiment, a message may also be presented to the user via the UI of the endpoint device that no USB port was found that can provide the requested service.

However, if another USB port is found at optional step 214, the method 200 may proceed to optional step 216. At optional step 216, the method 200 may provide a message indicating another one of the USB ports is available for the service that is requested. For example, the message may include the specific USB port number that can provide the requested service. The method 200 may then proceed to optional step 220.

At optional step 220, the method 200 determines if another USB port was selected. For example, the method 200 may determine if the USB port that was suggested in the message provided in the optional step 216 was selected. In one embodiment, the method 200 may wait a predefined period of time (e.g., 30 seconds or 1 minute, etc.). If another USB port is selected, the method 200 may return to step 210, where the method 200 receives an indication that a service is requested via the USB port and the method 200 may repeat steps 210-220. However, if another USB port is not selected (e.g., within the predefined period of time), the method 200 may proceed to step 222, where the method 200 ends.

As a result, the embodiments of the present disclosure transform the methods for selectively activating a USB port into an inventive application for allowing USB ports to be selectively configured and activated based on requested services rather than requiring the USB port to be completely on or completely off. Furthermore, the embodiments of the present disclosure improve the functioning of an endpoint device (e.g., computer, printer or multi-function device) by allowing the endpoint device to configure each USB port to be able to be selectively activated based upon a requested service.

It should be noted that although not explicitly specified, one or more steps, functions, or operations of the method 200 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 2 that recite a determining operation, or involve a decision, do not necessarily require that both branches of the determining operation be practiced. In other words, one of the branches of the determining operation can be deemed as an optional step.

FIG. 3 depicts a high-level block diagram of a general-purpose computer suitable for use in performing the functions described herein. As depicted in FIG. 3, the system 300 comprises one or more hardware processor elements 302 (e.g., a central processing unit (CPU), a microprocessor, or a multi-core processor), a memory 304, e.g., random access memory (RAM) and/or read only memory (ROM), a module 305 for selectively activating a universal serial bus (USB) port, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 305 for selectively activating a universal serial bus (USB) port (e.g., a software program comprising computer-executable instructions) can be loaded into memory 304 and executed by hardware processor element 302 to implement the steps, functions or operations as discussed above in connection with the exemplary method 200. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for selectively activating a universal serial bus (USB) port (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for selectively activating a universal serial bus (USB) port, comprising:
receiving, by a processor, a predefined list of services that are acceptable to work with the USB port;
configuring, by the processor, the USB port based on the predefined list of services;
receiving, by the processor, an indication that a service is requested via the USB port; and
providing, by the processor, the service via the USB port when the USB port is configured to provide the service based on the predefined list of services.

2. The method of claim 1, further comprising:
configuring, by the processor, each one of a plurality of different USB ports based on a different subset of services of the predefined list of services.

3. The method of claim 2, further comprising:
receiving, by the processor, a request for a service at one of the plurality of different USB ports;
determining, by the processor, that the service that is requested is not available on the one of the plurality of different USB ports based; and
providing, by the processor, a message indicating another one of the plurality of different USB ports that is available for the service that is requested.

4. The method of claim 1, wherein the predefined list of services comprises a communications protocol used by each service in the predefined list of services.

5. The method of claim 1, wherein the USB port comprises a USB port of a multi-function device (MFD).

6. The method of claim 5, wherein the configuring comprises modifying a USB port control module within an operating system of the MFD.

7. The method of claim 1, wherein the predefined list of services comprises at least one of: a storage via a USB thumb drive service, a thumb drive printing service, a near field communications (NFC) tap to print service, a USB firmware update or authentication service, an authorization and accounting (AAA) card authentication service.

8. The method of claim 1, wherein the predefined list of services is defined by an administrator and received by a graphical user interface of an endpoint device.

9. A non-transitory computer-readable medium storing a plurality of instructions which, when executed by a processor, cause the processor to perform operations for selectively activating a universal serial bus (USB) port, the operations comprising:
receiving a predefined list of services that are acceptable to work with the USB port;
configuring the USB port based on the predefined list of services;
receiving an indication that a service is requested via the USB port; and
providing the service via the USB port when the USB port is configured to provide the service based on the predefined list of services.

10. The non-transitory computer-readable medium of claim 9, further comprising:
configuring each one of a plurality of different USB ports based on a different subset of services of the predefined list of services.

11. The non-transitory computer-readable medium of claim 10, further comprising:
receiving a request for a service at one of the plurality of different USB ports;
determining that the service that is requested is not available on the one of the plurality of different USB ports based; and
providing a message indicating another one of the plurality of different USB ports that is available for the service that is requested.

12. The non-transitory computer-readable medium of claim 9, wherein the predefined list of services comprises a communications protocol used by each service in the predefined list of services.

13. The non-transitory computer-readable medium of claim 9, wherein the USB port comprises a USB port of a multi-function device (MFD).

14. The non-transitory computer-readable medium of claim 13, wherein the configuring comprises modifying a USB port control module within an operating system of the multi-function device (MFD).

15. The non-transitory computer-readable medium of claim 9, wherein the predefined list of services comprises at least one of: a storage via a USB thumb drive service, a thumb drive printing service, a near field communications (NFC) tap to print service, a USB firmware update or authentication service, an authorization and accounting (AAA) card authentication service.

16. The non-transitory computer-readable medium of claim 9, wherein the predefined list of services is defined by an administrator and received by a graphical user interface of an endpoint device.

17. A method for selectively activating a plurality of different universal serial bus (USB) ports of a multi-function device (MFD), comprising:
receiving, by a processor of the MFD, for each one of the plurality of different USB ports a respective predefined list of services that are acceptable to work with an associated one of the plurality of different USB ports;
configuring, by the processor, each one of the plurality of different USB ports based on the respective predefined list of services;
receiving, by the processor, an indication that a service is requested via one of the plurality of different USB ports;
determining, by the processor, whether the service that is requested is available on the one of the plurality of different USB ports that received the request for the service;
providing, by the processor, the service via the one of the plurality of different USB ports when the one of the plurality of different USB ports is configured to provide the service based on the respective predefined list of services; and
providing, by the processor, a message indicating another one of the plurality of different USB ports that is available for the service that is requested when the service is not available via the one of the plurality of different USB ports that received the request for the service and when the service is available via the another one of the plurality of different USB ports.

18. The method of claim 17, wherein the predefined list of services comprises a communications protocol used by each service in the predefined list of services.

19. The method of claim 17, wherein the predefined list of services comprises at least one of: a storage via a USB thumb drive service, a thumb drive printing service, a near field communications (NFC) tap to print service, a USB firmware update or authentication service, an authorization and accounting (AAA) card authentication service.

20. The method of claim 17, wherein the configuring comprises modifying a USB port control module within an operating system of the MFD.
